(19) United States
(12) Patent Application Publication
(10) Pub. No.: US 2016/0085440 A1
(43) Pub. Date: Mar. 24, 2016

(54) SYSTEMS AND METHODS FOR PROVIDING AN ANATOMICALLY ADAPTABLE KEYBOARD

(71) Applicant: Qualcomm Incorporated, San Diego, CA (US)

(72) Inventors: Michael-David Nakayoshi Canoy, San Diego, CA (US); Zachary David Rattner, San Diego, CA (US); Stephen Alton Sprigg, Poway, CA (US); Paul Eric Jacobs, San Diego, CA (US)

(21) Appl. No.: 14/490,745

(22) Filed: Sep. 19, 2014

(51) Int. Cl. G06F 3/0488; G06F 3/0484; G06F 3/023

(52) U.S. Cl. CPC G06F 3/04886; G06F 3/0236; G06F 3/04842

(57) ABSTRACT

An improved wireless device generates a customized representation of a keyboard for a touch-sensitive screen. The wireless device generates an anatomical model specific to the operator of the wireless device in response to an operator contacting their fingertips in a “typing” position as if the operator were about to use a standard QWERTY keyboard. The anatomical model is used to derive a keyboard layout optimized for a present operator of the wireless device.

### DESCRIPTION OF THE RELATED ART

Mobile devices, such as wireless communication devices or mobile computing devices continue to proliferate. Mobile devices continue to have more capability in ever-decreasing physical form factor packages. One of the primary ways of providing input to a wireless communication devices or mobile computing device is through a touch-sensitive screen. In some devices, a QWERTY keyboard can be rendered on the touch screen and an operator can type input commands on the touch-sensitive screen.

Unfortunately, a QWERTY keyboard rendered on a touch-sensitive screen has drawbacks, such as, for example, the inability to accommodate operators having different size hands and fingers, no physical mechanism to provide feedback to show the keys to the operator, limited tactile feedback to let the operator know that they are on a particular key, or set of keys, and other drawbacks.

Therefore, it would be desirable to be able to improve a wireless device having a touch-sensitive screen.

### SUMMARY

An improved wireless device generates a customized input interface for a touch-sensitive screen. The wireless device generates an anatomical model specific to the operator of the wireless device. The anatomical model is used to derive a keyboard layout for a present operator of the wireless device.

An example method for adapting a representation of a keyboard on a wireless device includes the steps of using a touch-sensitive input/output device to receive substantially simultaneous respective inputs from an operator's fingers at rest and in contact with the touch-sensitive input/output device, determining spatial parameters from the respective inputs and rendering on the touch-sensitive input/output device, a first set of keys in response to the spatial parameters.

A wireless device includes a touch-sensitive input/output device and a baseband subsystem. The touch-sensitive input/output device is arranged with a digitizer and a display. The baseband subsystem is in communication with the touch-sensitive input/output device and includes a processor, a graphics processing unit, and a memory. The memory is arranged with a keyboard module having at least a calibration detection module responsive to substantially simultaneous respective inputs from an operator's fingers at rest and in contact with the touch-sensitive input/output device.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a block diagram illustrating an example of a wireless device, in which an anatomically adaptable keyboard can be implemented.

FIG. 2 is a schematic diagram of the keyboard module of FIG. 1.

FIG. 3 is a flow chart illustrating an exemplary embodiment of a method for generating an anatomically adaptable keyboard.

FIG. 4 is a schematic diagram showing an example embodiment of key geometry.

FIGS. 5A and 5B are schematic diagrams showing operator input impressions on a touch-sensitive input output device of FIG. 1 and an embodiment of home row keys arranged in registration with the input impressions.

FIGS. 6A and 6B are schematic diagrams showing illustrative intermediate home row key placement based on the home row key geometry of FIG. 5.

FIG. 7 is a schematic diagram showing how keys adjacent to the home row keys are placed while leaving areas for other keys in a modified keyboard.

FIG. 8 is a schematic diagram showing an embodiment of key grouping.

FIG. 9 is a schematic diagram showing an embodiment of non-rectangular keys.

FIGS. 10A and 10B are schematic diagrams illustrating an overlap condition or conflict between the area and position of adjacent keys.

FIG. 11 is a schematic diagram illustrating identification of a respective reference before moving an overlapping key.

FIGS. 12A-12E include schematic diagrams illustrating the creation, identification and correction of an overlap condition for adjacent keys.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “operator device” and “client device” include a device that can be capable of receiving textual input from an operator. The operator device may be a personal computing device such as a tablet computing device, a pad computing device, or a smartphone. An operator device may also be a wearable device that can interact with other operator devices, whether or not being connected to, or able to connect to a web site or server. An operator device or client device can be a stationary device, a wireless device, a wearable device, or another device. The terms “operator device” and “client device” can be used interchangeably.

As used herein, the term “operator” refers to an individual using or wearing an operator device. In some arrangements, an operator of an operator device can use the operator device to transmit information to and receive information from a separate device via a wired connection (e.g., using a universal serial bus) or a wireless connection (e.g., using one or more of Wi-Fi, Bluetooth, IRDA, etc.) to communicate via or with the other device.

As used herein, the term “spatial parameters” refers to attributes of any or all relationships between an operator of the operator device and a touch-sensitive input element of the operator device, such as characteristics of one or more impressions resulting from contact between the operator and the touch-sensitive input element.

As used herein, the term “context” refers to any or all attributes of the operator or the operator device, such as physical, logical, social, historical and other contextual information.

In an exemplary embodiment, the anatomically adaptable keyboard can comprise a software module that can be configured to measure specific characteristics of the operator's hand and present a keyboard that is optimally sized for the personal skeletal geometry of the operator. The specific methods used in the anatomically adaptable keyboard allow the key regions to be adapted in a way that increases typing accuracy and speed over a traditional software enabled keyboard.

In an exemplary embodiment, a wireless device having the anatomically adaptable keyboard can be used as an input device for another device, such as a laptop computing device, a desktop computing device, or other devices.

In an exemplary embodiment, the anatomically adaptable keyboard can keep track of the locations at which an operator's fingers touch the screen and adapt the size, location, and relative positioning of the keys over time based on actual locations of finger contact.

In an exemplary embodiment, the anatomically adaptable keyboard can dynamically group keys together and later disambiguate taps on grouped keys to determine the intended input.

In an exemplary embodiment, the anatomically adaptable keyboard can detect when an operator has placed the left-hand fingers and right-hand fingers together along the touch-sensitive input/output device. Such simultaneous operator inputs, which result from an operator placing their fingertips in contact with home row keys are ignored.

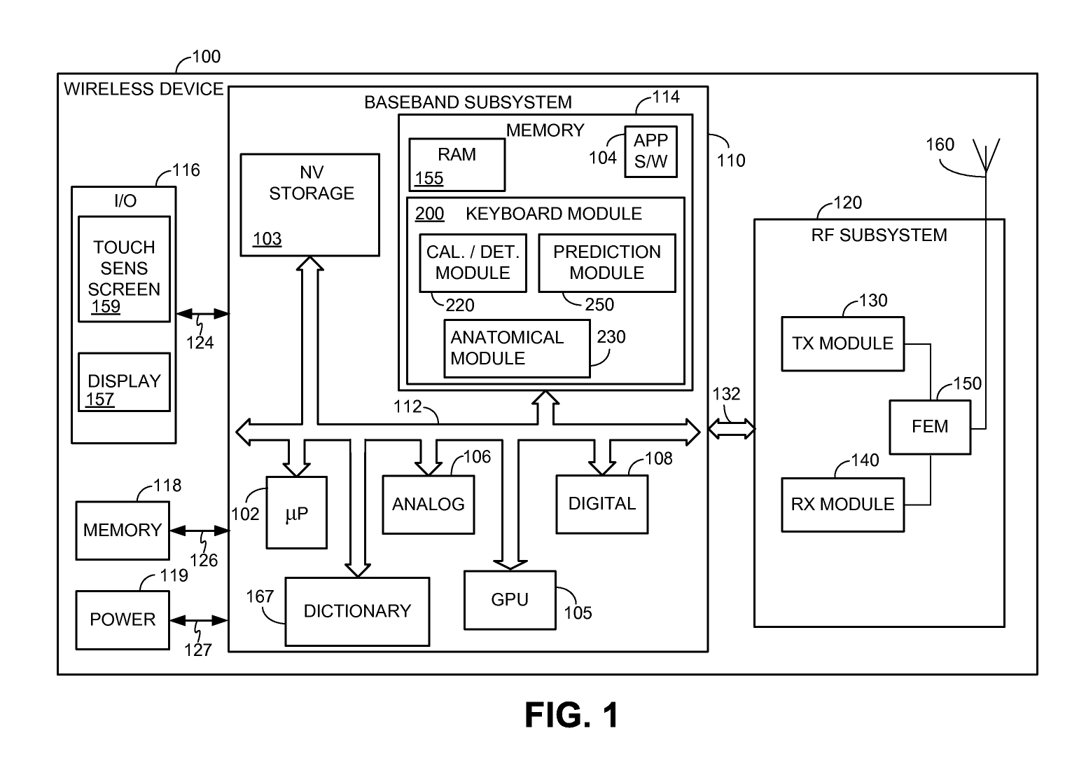

FIG. 1 is a block diagram illustrating an example of a wireless device, in which exemplary embodiments of an anatomically adaptable keyboard can be implemented. In an embodiment, the wireless device 100 can be a mobile computing device, such as a tablet computing device, a pad computing device, or another mobile computing device. In an exemplary embodiment, the wireless device 100 may have wireless communication capability including, for example, “Bluetooth” wireless communication; portable cellular wireless communication; WiFi enabled communication; Infrared (IR) wireless communication; or any other wireless communication capability. Embodiments of the anatomically adaptable keyboard can be implemented in any wireless device in which it is desirable to enable a keyboard. The wireless device 100 illustrated in FIG. 1 is intended to be a simplified example of a cellular telephone and to illustrate one of many possible applications in which the anatomically adaptable keyboard can be implemented. One having ordinary skill in the art will understand the operation of a portable cellular telephone, and, as such, implementation details are omitted. In an embodiment, the wireless device 100 includes a baseband subsystem 110 and an RF subsystem 120 connected together over a system bus 132. The system bus 132 can comprise physical and logical connections that couple the above-described elements together and enable their interoperability. In an embodiment, the RF subsystem 120 can be a wireless transceiver. Although details are not shown for clarity, the RF subsystem 120 generally includes a transmit module 130 having modulation, upconversion and amplification circuitry for preparing a baseband information signal for transmission, a receive module 140 having amplification, filtering and downconversion circuitry for receiving and downconverting an RF signal to a baseband information signal to recover data, and further includes a front end module (FEM) 150 that includes diplexer circuitry, duplexer circuitry, or any other circuitry that can separate a transmit signal from a receive signal, as known to those skilled in the art. An antenna 160 is connected to the FEM 150. In an exemplary embodiment, the RF subsystem 120 can be configured for Bluetooth communication, WiFi communication, or another wireless communication methodology.

The baseband subsystem 110 generally includes a processor 102, which can be a general purpose or special purpose microprocessor, memory 114 storing, for example application software 104, analog circuit elements 106, digital circuit elements 108, a graphics processor unit (GPU) 105, a non-volatile storage element 103, and a dictionary 167 coupled to one another over a system bus 112. The system bus 112 can comprise the physical and logical connections to couple the above-described elements together and enable their interoperability. A power source 119 can also be coupled to the baseband subsystem 110 over connection 127 to provide power to the wireless device 100. In an exemplary embodiment, the power source 119 can be a rechargeable or disposable battery.

A touch-sensitive input/output device 116 is connected to the baseband subsystem 110 over connection 124, and a memory element 118 is coupled to the baseband subsystem 110 over connection 126. The touch-sensitive input/output device 116 can include, for example, a display 157, a touch-sensitive screen 159, a microphone (not shown), a speaker (not shown), a vibrator (not shown), a pointing device (not shown), operator interface control elements, and any other devices or system that allow an operator to provide input commands and receive outputs from the wireless device 100. In an exemplary embodiment, the touch-sensitive screen 159 may be incorporated with the display 157 into a single element having both touch-sensitive input capability and display capability. In an exemplary embodiment, the touch-sensitive screen 159 can have multi-touch capabilities with the ability to determine touch or contact point parameters, such as for example, touch size, touch pressure, touch area, touch duration, etc.

The memory 118 can be any type of volatile or non-volatile memory, and in an embodiment, can include flash memory. The memory 118 can be permanently installed in the wireless device 100, or can be a removable memory element, such as a removable memory card.

The memory 114 may also include random access memory 155, and a keyboard module 200. In an exemplary embodiment, the keyboard module 200 may comprise one or more modules, instructions, executable software or firmware, etc., to allow the wireless device 100 to determine an anatomy of an operator's fingers and hands from spatial parameters, and render a keyboard on the display 157 that anatomically matches the operator's hands and fingers. In an exemplary embodiment, the keyboard module 200 comprises a calibration mode detection module 220, an anatomical module 230 and a prediction module 250. The keyboard module 200 also communicates with the dictionary 167 over the system bus 112. In alternative arrangements. The dictionary 167 is integrated with a history module in the memory 114. In addition to determining appropriate locations for the separate keys of the adaptable keyboard, the anatomical module 230 includes a set of layout parameters 235 that are forwarded to the GPU 105 which is responsible for sending appropriately formatted commands to the touch-sensitive input/output device 116 for reproducing a representation of a keyboard on the display 157. The anatomical module 230 measures contact point characteristics when the operator places their fingertips on the touch sensitive screen 159 to generate an initial layout of the keyboard. After the keyboard is presented, the keyboard module 200 transitions into an operational mode where subsequent touches of an operator's finger tips in registration with the rendered keyboard keys are communicated with application software 104 executing on the wireless device 100 and/or communicated to remote devices via a USB port (not shown) or the RF subsystem 120.

In an example embodiment when the wireless device 100 is in the operational mode, the keyboard module 200 determines when an operator has substantially simultaneously placed two or more fingers on the touch sensitive screen 159 in registration with the home-row keys and does not register or consider the corresponding impressions or inputs. In this regard, substantially simultaneously means at about the same time or within a threshold time. Thus, the nearly simultaneous operator placement or return of fingertips to the home-row keys does not result in a recorded keyboard input. In an example embodiment, this home-row threshold time is about 5 milliseconds. The home-row threshold time may be preconfigured or operator adjustable. In alternative embodiments the home-row threshold time may be shorter than 5 milliseconds or longer than 5 milliseconds (ms).

In response to a subsequent operator input (e.g., a key strike) associated with any of the rendered keys, the keyboard module 200 enables a feedback mechanism and a character associated with the key in registration with the operator input is communicated to an application interface. The feedback mechanism may include a visually perceptible adjustment in the size, color, perspective, or other characteristics of the key selected or struck by the operator.

The keyboard module 200 may also play one or more sounds as a key is “selected” and subsequently “released.” The sounds may include a unique sound as the key is selected and a second distinct sound as the key is released. These sounds may be repeatedly played in association with each key on the rendered keyboard. Alternatively, distinct sounds may be associated with one or more keys such as the home row keys to provide information to the operator regarding the placement of the operator's fingers on the touch sensitive screen 159.

In addition, the feedback may include a vibration enabled by communicating a signal to a vibrator arranged in the wireless device 100. In this regard, the keyboard module 200 may be arranged to vibrate the wireless device 100 with a variable intensity responsive to the distance between an operator's impression on the touch-sensitive screen 159 and the center of the rendered key. For example, in one arrangement, the intensity may be at a maximum when the operator's impression is in registration with the center of the rendered key. Conversely, in an alternative arrangement, the intensity of the vibration may be at a maximum when the operator's impression is not in registration with the center of the rendered key but closer to the edge of the rendered key. This alternative arrangement may alert an operator that their finger placement has drifted from the original rendered location of the home-row keys on the adaptable keyboard.

While the wireless device 100 is functioning in the operational mode, the prediction module 250 is enabled and collects input in the form of characters responsive to the location of the impressions or strikes entered by the operator on the touch sensitive screen 159 in registration with the rendered keyboard, queries the dictionary 167 and/or historical information to determine which keys are likely to come next, and uses the operator inputs, dictionary information and historical information to adjust elements on the rendered keyboard. The prediction module 250 includes logic that will identify unique intended characters in response to an entered character sequence that matches a word from the dictionary 167. When the prediction module 250 is unable to identify a unique match, the prediction module 250 includes logic arranged to determine the likelihood of an operator's next key strike or subsequent key strikes using one or more dictionary entries and/or a measure of the frequency of previously entered characters or character sequences in the form of words. Thus, the keyboard module 200 is arranged to present a likely next subsequent character (e.g., a letter), characters and in some situations two or more characters, the concatenation of which with the preceding characters forms a word.

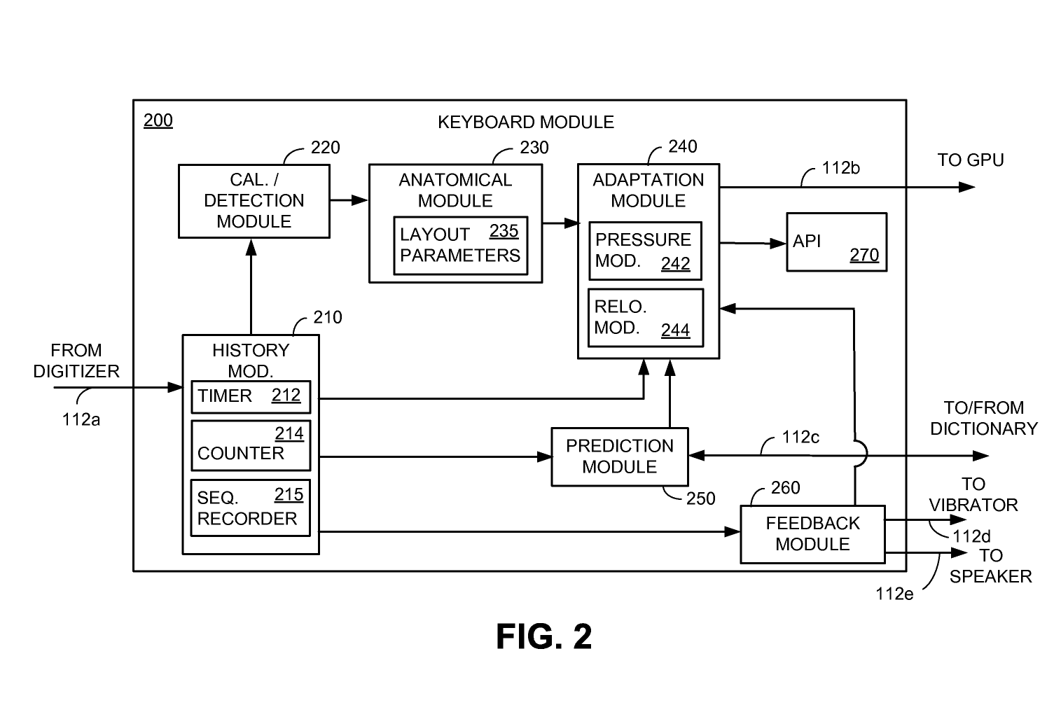

In an alternative exemplary embodiment, the keyboard module 200, including any of or all of the calibration mode detection module 220, the anatomical module 230 and the prediction module 250, among other modules described in association with the description of FIG. 2, may be implemented in hardware, or in a combination of hardware and software.

The processor 102 can be any processor that executes the application software 104 to control the operation and functionality of the wireless device 100. The processor 102 can also execute the keyboard module 200. The memory 114 can be volatile or non-volatile memory, and in an embodiment, can be non-volatile memory that stores the application software 104, the keyboard module 200 and the dictionary 167.

The analog circuitry 106 and the digital circuitry 108 include the signal processing, signal conversion, and logic that convert an input signal provided by the touch-sensitive input/output device 116 to an information signal that is to be transmitted. Similarly, the analog circuitry 106 and the digital circuitry 108 include the signal processing elements used to generate an information signal that contains recovered information from a received signal. The digital circuitry 108 can include, for example, a digital signal processor (DSP), a field programmable gate array (FPGA), or any other processing device. Because the baseband subsystem 110 includes both analog and digital elements, it can be referred to as a mixed signal device (MSD).

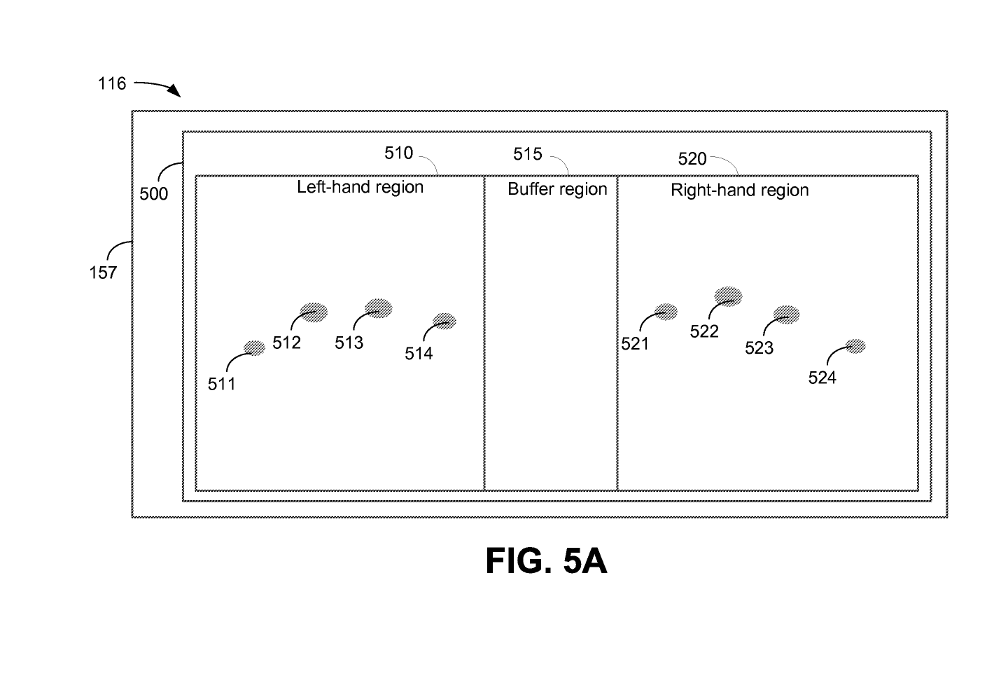

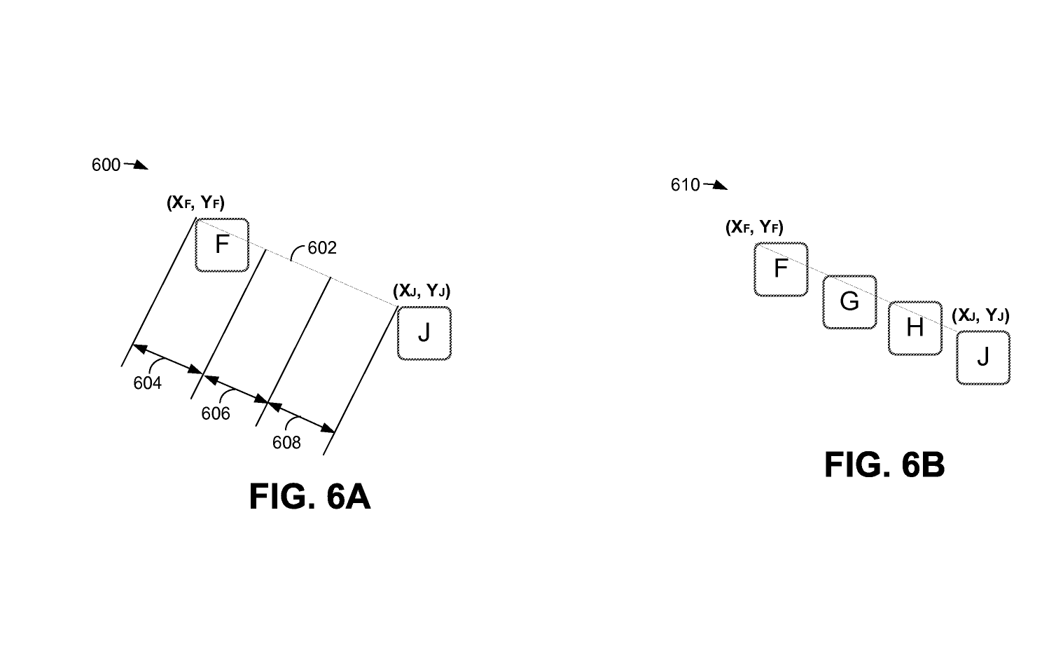

FIG. 2 is a schematic diagram of the keyboard module 200 introduced in FIG. 1. In some embodiments, the keyboard module 200 will respond to application software 104 or other input signals by directing the GPU 105 to render labeled regions (see, for example, FIG. 5A, FIG. 5B and FIG. 7) to guide the operator on where to position their hands to initiate a process for generating an adaptable keyboard. As indicated in FIG. 2, the keyboard module 200 receives operator initiated input information on connection 112a from a digitizer (not shown), which in some embodiments may be an integral component of the touch-sensitive input/output device 116 or may be implemented as a combination of the capabilities of the analog circuits 106 and the digital circuits 108 of the baseband subsystem 110.

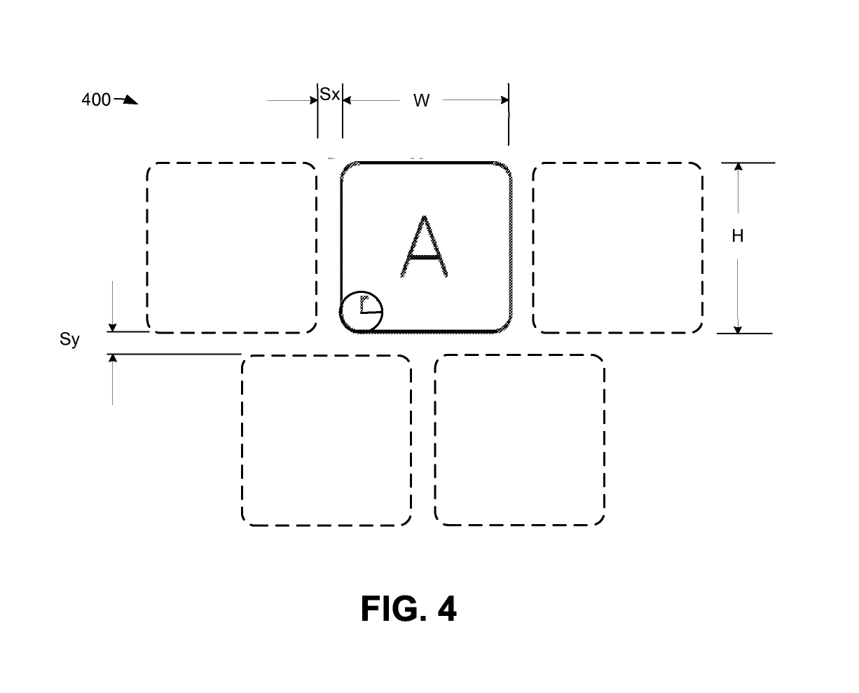

The connection 112a forwards the digitizer signals to a history module 210. The history module 210 in addition to including buffers for recording the locations and sizes of key taps along the surface of the touch-sensitive input/output device 116, as reported by the digitizer (not shown), further includes a timer 212, a counter 214, and a sequence recorder 215. The timer 212 provides a mechanism for identifying the relative timing between select impressions made by an operator. In operation, the history module 210 uses the timer 212 and information from the digitizer to identify when an operator has substantially simultaneously placed the fingertips of their left and right hands on the surface of the touch-sensitive input/output device 116. When the history module 210 determines that the operator has contacted the touch-sensitive input/output device 116 in this manner, the keyboard module enables the calibration module 220, which determines the size and locations of the operator inputs. The size and location information is communicated to the anatomical module 230, which uses this information to define a model of the operator's hands. Once the model is available, the anatomical module 230 generates layout parameters 235 that define the position and size of keyboard keys arranged to receive taps from the fingertips of the operator's hands. Example layout parameters 235 are illustrated and described in association with FIG. 4. The keyboard keys are associated with the letters found on the home row of a QWERTY keyboard. Once the home row is defined the keyboard module 200 generates information that is communicated to the GPU 105 to render a keyboard as illustrated and described in association with FIGS. 4-8.

When the operator is simultaneously contacting two or more of the home row keys, the keyboard module 200 will not record inputs from the two or more home row keys. Upon a subsequent tap of the touch-sensitive input/output device 116, the keyboard module 200 transitions into a record or operational mode where a character associated with the location of the subsequent tap is recorded as a data entry by the operator. The example rendered keyboards will continue to convert the separate and non-simultaneous operator touch inputs into respective letters or punctuation characters for input that can be used by application software 104 executing on the wireless device 100. When acting as an input device to application software 104 executing on the wireless device 100, the keyboard module 200 communicates one or more signals to an application programming interface (API) 270.

Alternatively, the RF subsystem 120 (FIG. 1), an infrared data association (IrDA) interface (not shown) or a light-emitting diode (not shown) arranged on the wireless device 100 can be used to forward signals responsive to the operator inputs on the example rendered keyboards to generate input signals for any number of devices that can receive and process the signals.

In operation, when two or more operator inputs are detected with respective timestamps that do not differ from each other by more than a threshold time, the keyboard module 200 will not record or associate the operator's touches with corresponding characters. In an example embodiment, the threshold time is about 5 ms. When this is the case, the keyboard module 200 may use the feedback module 260 to generate signals that when communicated to the appropriate output device will create visual, aural or haptic feedback that can be detected by an operator of the wireless device 100 to alert them that the adaptable keyboard was unable to identify the intent of the operator inputs.

After the keyboard module 200 is operating in the operational mode, when it is determined that the operator is simultaneously contacting two or more of the home row keys, the keyboard module 200 will not record inputs from the two or more home row keys. When this is the case, the keyboard module 200 enables a feedback mechanism to alert the operator and characters associated with the keys in registration with the substantially simultaneous impressions are not recorded and are not communicated to the API 270. When this is the case, upon detection of a subsequent tap of the touch-sensitive input/output device 116, the keyboard module 200 transitions again into a record or operational mode where a character associated with the location of the subsequent tap is recorded as a data entry.

The counter 214 includes logic that identifies characters that are entered between adjacent space bar inputs and/or between a punctuation character and a space bar input. The identified characters may represent a word, a number, or a series of symbols in any combination. The identified characters are communicated to the sequence recorder 215.

The sequence recorder 215 generates a record for each identified word, number, or sequence of symbols recorded by the wireless device 100. In addition, the sequence recorder 215 may be arranged to associate additional information that can be used by logic in the prediction module 250 to determine the likelihood that the user intends to enter a particular word, number or sequence of symbols. The additional information may include a measure of the frequency of usage for the present session where a session includes the time the keyboard module 200 has been active. Alternatively and/or additionally, the sequence recorder 215 may be arranged to include a measure of the frequency of usage for more than one session of use of the keyboard module 200. That is, historical usage information may be persistently stored in a non-volatile storage 103 (FIG. 1).

The keyboard module 200 receives inputs from and sends one or more output signals at appropriate or designated times on respective connections of the system bus 112. For example, as indicated in FIG. 2, the feedback module 260 may generate one or more signals that are communicated to an adaptation module 240 before being forwarded on connection 112b to the GPU 105. These signals may be interpreted or converted to change one of more visual characteristics of the key associated with the operator input. For example, the rendered representation of the key may be shaded, presented in an opaque or transparent form, changed in size or color, or otherwise visually manipulated when an operator fingertip is in contact with the touch-sensitive input/output device 116. In a first state, the rendered keys will have a first set of visually discernable characteristics. In a second state, such as when the key is selected by an operator, the rendered key will have a second set of visually discernable characteristics.

The adaptation module 240 is arranged with a pressure module 242 and a relocation module 244. The pressure module 242 includes logic arranged to determine a measure of the pressure being applied by an operator's fingertip or thumb as it is being applied against the surface of the touch-sensitive input/output device 116. The adaptation module 240 may use information provided from the pressure module 242 to adjust the size of one or more keys of the rendered keyboard over time as an operator's use of the keyboard changes over the course of an input mode session. Similarly, the relocation module 244 includes logic that monitors the positions of operator impressions or inputs over the course of an input mode session. The adaptation module 240 may use information provided by the relocation module 244 to adjust the position or location of one or more of the rendered keys of the adaptable keyboard to increase the likelihood of achieving a match between an intended key strike and the recorded key strike. For example, if the strike or impression location associated with a particular key is drifting in a consistent direction, the adaptation module 240 may move the position of the key so that it remains in registration with the key strikes likely intended for the particular key.

In addition, the capability to provide visual feedback allows the adaptation module 240 to receive information from the prediction module 250 concerning the likelihood that a particular key will be entered. The adaptation module 240 may forward signals on connection 112b that instruct the GPU 105 to change a visually perceptible characteristic of one or more keys of the adaptable keyboard based on the likelihood that the key will be entered by the operator.

A “Bksp” (i.e., a backspace) or other key is rendered by the keyboard module 200 to provide a mechanism for an operator of the wireless device 100 to communicate a desire to avoid the last adaptation or change made to the rendered keyboard. The Bksp or other key further provides a mechanism for an operator of the wireless device 100 to remove an entry from or otherwise adjust an entry in the sequence recorder 215. For example, when a potential word is selected or entered in error, the selection of the Bksp key or other key directs the sequence recorder 215 to decrement a count or measure of the frequency of use of the associated word in the sequence recorder 215 and removes the potential word from a buffer (not shown) coupled to the GPU 105 or the API 270.

As further indicated in FIG. 2, additional output signals are communicated from the feedback module 260 on connection 112d to a vibrator (not shown). These haptic feedback signals may vary the intensity and duration of a vibration.

In addition, aural feedback can be communicated via signals on connection 112e forwarded to one or more speakers. The aural feedback may include a first sound as a key is struck (i.e., a key strike) and a second sound different from the first sound when the operator removes or releases a fingertip from the touch-sensitive input/output device 116 (i.e., a key release).

Information communicated to and received from the dictionary 167 is transferred along connection 112c. The information will include words that may include a match for keys not yet entered by an operator.

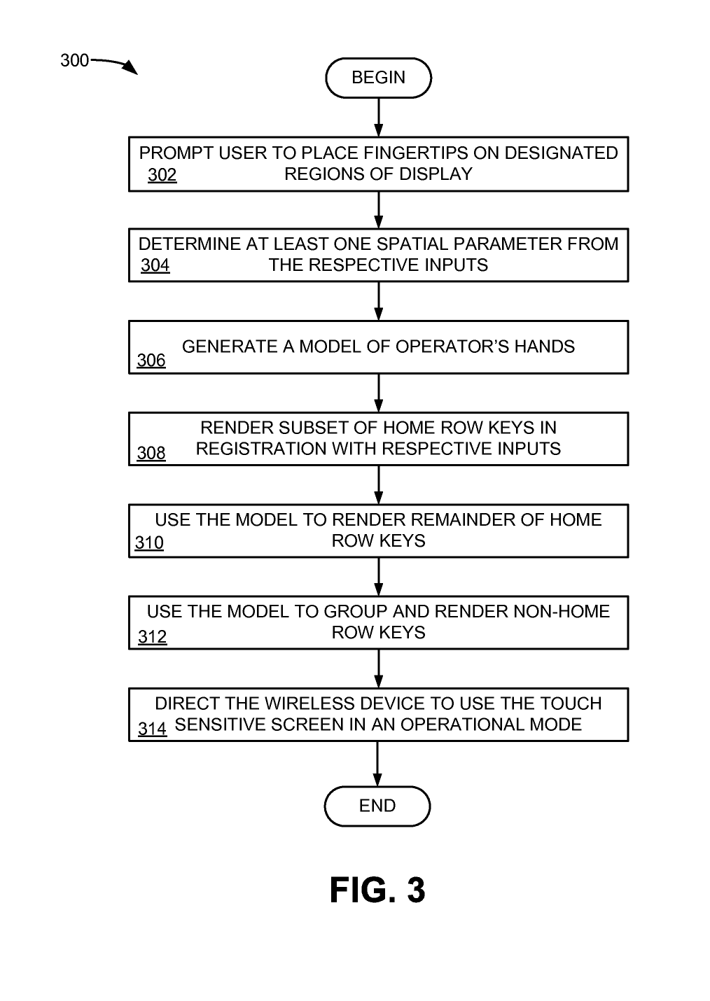

FIG. 3 is a flow chart illustrating an exemplary embodiment of a method 300 for generating an anatomically adaptable keyboard. The blocks in the method 300 can be performed in or out of the order shown.

In block 302, the keyboard module 200 or application software 104 prompts an operator to place their hands in a normal typing position so that the operator's fingers rest on the surface of the touch-sensitive screen 159. As further indicated in block 302, one or more visual aids (e.g., lines defining left-hand and right-hand regions, color filled regions, or shaded regions) may be rendered with the display 157 of the touch-sensitive input/output device 116.

In block 304, the calibration mode detection module 220 measures one or more parameters of the operator's hands and fingers. In an exemplary embodiment, the calibration mode detection module 220 can be configured to record the location and measure the size of each contact point, that is, the size of the area on which the operator's fingers come into contact with the touch-sensitive screen 159. In an exemplary embodiment, the anatomical module 230 can be configured in response to one or more of the locations, sizes and the amount of pressure exerted at each contact point, that is, the pressure exerted on the area on which the operator's fingers come into contact with the touch-sensitive screen 159.

In an alternative embodiment, the history module 210 can be configured to measure the duration of each contact point, that is, the amount of time during which the operator's fingers come into contact with the touch-sensitive screen 159.

In an alternative embodiment, the anatomical module 230 can be configured to measure the amount of area covered by each contact point, that is, the amount of area covered by each of the operator's fingers on the touch-sensitive screen 159.

In block 306, the anatomical module 230 defines a distance, or spacing, between each contact point. For example, the anatomical module 230 measures the distance between each of the operator's fingers and generates an anatomical model of the operator's hands and fingers.

Referring momentarily to FIG. 5A, illustrative operator inputs in the form of contact regions or impressions are shown. A keyboard 500 of the touch-sensitive input/output device 116 is rendered, or drawn, on the display 157 as directed by the GPU 105 and the anatomical module 230. In an exemplary embodiment, the keyboard region is separated or sub-divided into multiple regions. For example, the keyboard region comprises a left-hand region 510, a right-hand region 520 and an intervening buffer region 515. The wireless device may be arranged to prompt an operator in some way to place the fingers of the operator's left-hand in a natural or comfortable “typing” position in the left-hand region 510 and the fingers of the operator's right-hand in a natural or comfortable “typing” position in the right-hand region 520. The prompt may be communicated aurally or visually.

As indicated in FIG. 5A, contact region 511 is the impression made by an operator's fifth digit or fourth finger of the left hand. Contact region 512 is the impression made by an operator's fourth digit or third finger of the left hand. Contact region 513 is the impression made by an operator's third digit or second finger of the left hand. Contact region 514 is the impression made by an operator's second digit or index finger of the left hand. Contact region 524 is the impression made by an operator's fifth digit or fourth finger of the right hand. Contact region 523 is the impression made by an operator's fourth digit or third finger of the right hand. Contact region 522 is the impression made by an operator's third digit or second finger of the right hand. Contact region 521 is the impression made by an operator's second digit or index finger of the right hand.

Referring momentarily to FIG. 4, key geometry can be defined with the following layout parameters 235:
Sx: horizontal space between adjacent keys;
Sy: vertical space between adjacent keys;
W: unit key width; (Some keys' widths can be integral multiples of this value.)
H: unit key height; (Some keys' heights can be integral multiples of this value); and
r: border radius, corresponding to N pixels, where N is a positive integer.

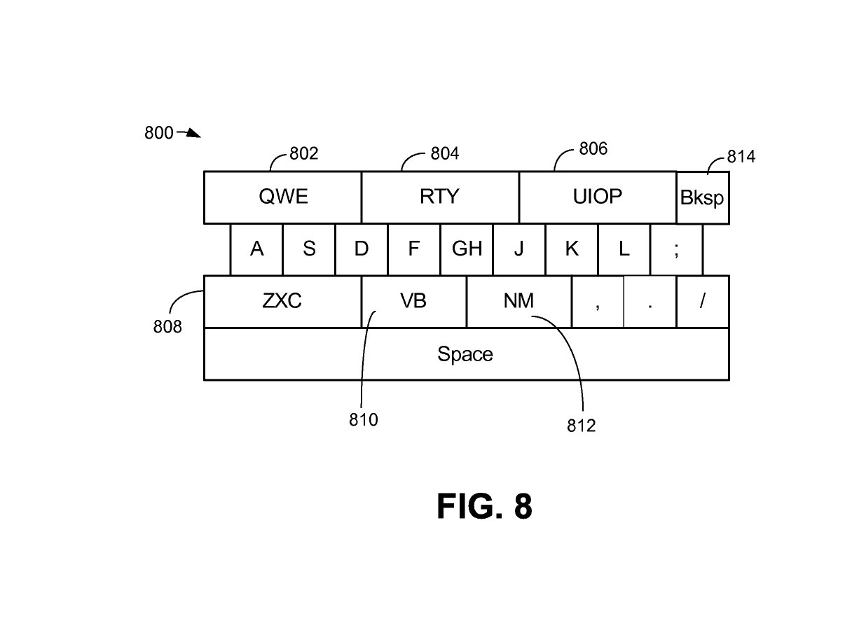

The adaptation module 240 may be configured to apply minimum horizontal and vertical spaces between adjacent keys when so desired. In alternative arrangements, such as the embodiment illustrated in FIG. 9, the adaptation module 240 may be configured to apply no minimum spaces in both the X and Y dimensions between adjacent keys. The adaptation module 240 may also be configured to apply minimum and/or maximum unit key heights and unit key widths when so desired.

In block 308, the anatomical module 230 generates information, which when communicated to the GPU 105, directs the GPU 105 to render an operator specific keyboard layout on the display 157 of the touch-sensitive input/output device 116. This includes rendering the home row keys in registration with the touch inputs entered by the operator. As indicated in FIG. 5B, the home row keys include the familiar QWERTY “home keys” of “A”, “S”, “D”, “F”, “J”, “K”, “L” and “;”.

Referring momentarily to FIG. 5B, illustrative home row key geometry is shown. The keyboard 500 is rendered, or drawn, on the display 157 as directed by the GPU 105 and the anatomical module 230. In an exemplary embodiment, the keyboard 500 comprises a left-hand region 510, a right-hand region 520 and an intervening buffer region 515. In an exemplary embodiment, the home keys A, S, D and F are rendered in the left-hand region 510 and the home keys J, K, L and; are rendered in the right-hand region 520 according to the anatomical model developed by the anatomical module 230 in blocks 302, 304 and 306. As illustrated, the eight home keys A, S, D, F, J, K, L and; are rendered in registration with a corresponding fingertip of the operator and are members of a first subset of home row keys. More specifically, key 516 (also known as the A key) is in registration with the contact region or impression made by an operator's fifth digit or fourth finger of the left hand. Key 517 (also known as the S key) is in registration with the contact region or impression made by an operator's fourth digit or third finger of the left hand. Key 518 (also known as the D key) is in registration with the contact region or impression made by an operator's third digit or second finger of the left hand. Key 519 (also known as the F key) is in registration with the contact region or impression made by an operator's second digit or index finger of the left hand. Moving to the right-hand region 520, key 529 (also known as the “;” key) is in registration with the contact region or the impression made by an operator's fifth digit or fourth finger of the right hand. Key 528 (also known as the L key) is in registration with the contact region or the impression made by an operator's fourth digit or third finger of the right hand. Key 527 (also known as the K key) is in registration with the contact region or the impression made by an operator's third digit or second finger of the right hand. Key 526 (also known as the J key) is in registration with the contact region or the impression made by an operator's second digit or index finger of the right hand.

In block 310, the anatomical module 230 in response to the layout parameters 235 and logic arranges the “G” key 735 and the “H” key 737 (FIG. 7) in response to the rendered location of the keys respectively associated with the left-hand and right-hand index fingers. The “G” key 735 and the “H” key 737 are members of a second subset of home row keys separate from the first subset of home row keys.

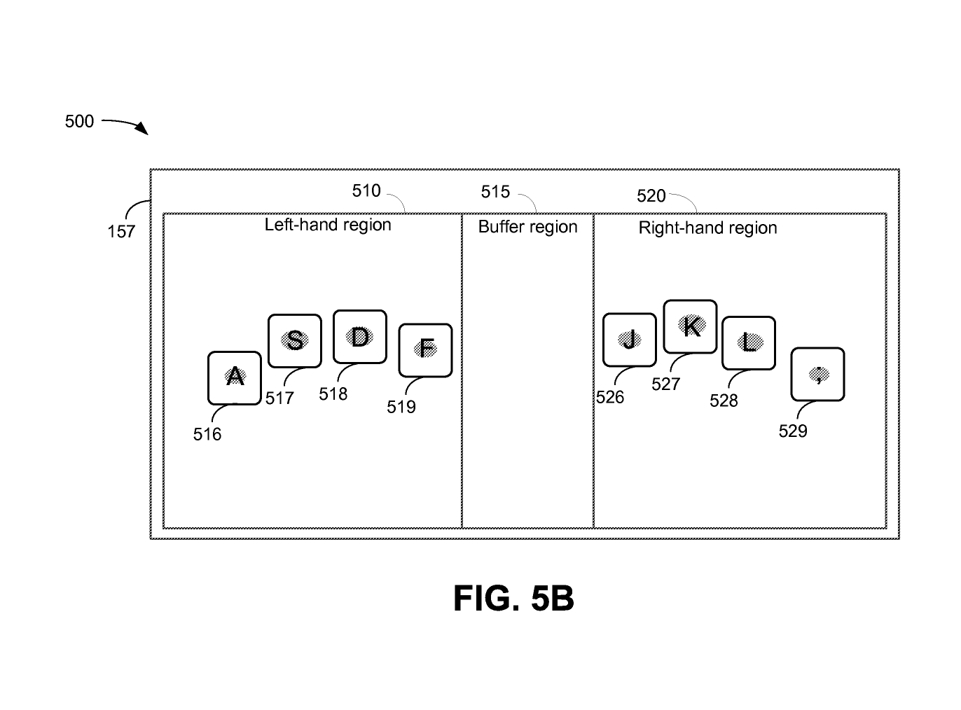

FIGS. 6A and 6B are schematic diagrams showing illustrative key placement based on the home key geometry of FIG. 5B. Referring to FIG. 6A, the positions of the G and the H keys are derived by connecting the upper-left corners of the F and J keys by an imaginary line 602 and partitioning the line into three equal segments 604, 606 and 608. The imaginary line 602 is identified by a point (X_{F}, Y_{F}) and another point (X_{J}, Y_{J}).

Referring to FIG. 6B, the upper left-hand corner of the G key is then located at a point identified by

$$( {X}_{J} + \frac{{X}_{J} - {X}_{F}}{3} , {Y}_{J} + \frac{{Y}_{J} - {Y}_{F}}{3} )$$

along the imaginary line 602 (which is not rendered on display 157) and the upper left-hand corner of the H key is located at a point identified by

$$( {X}_{J} + \frac{2 ( {X}_{J} - {X}_{F} )}{3} , {Y}_{J} + \frac{2 ( {Y}_{J} - {Y}_{F} )}{3} ) .$$

In block 312, the anatomical model 230, in response to the layout parameters 235 and logic, arranges additional keys adjacent to the home row keys on the adaptive keyboard. Each home row key has a certain set of keys above and below the respective home row key. That is, the keyboard module 200 determines how the remainder of the keyboard should be presented once the home row has been defined. For example, as shown in FIG. 7, the home row key A is located on the display 157 such that respective areas are available for the Q key 712 and the Z key 711, which are shown with dashed lines. When the wireless device 100 has a large enough touch-sensitive input/output device 116 and is configured to do so, the wireless device 100 presents a pseudo QWERTY keyboard (i.e., an operator customized keyboard with single character keys in a row above and adjacent to the home row keys and single character keys in a row below and adjacent to the home row keys). These non-home row keys are illustrated in the embodiment shown in FIG. 7 in dashed lines. Space permitting, the keyboard module 200 may also render addition keys such as a space bar 736 and/or number keys and function keys (not shown) as may be desired.

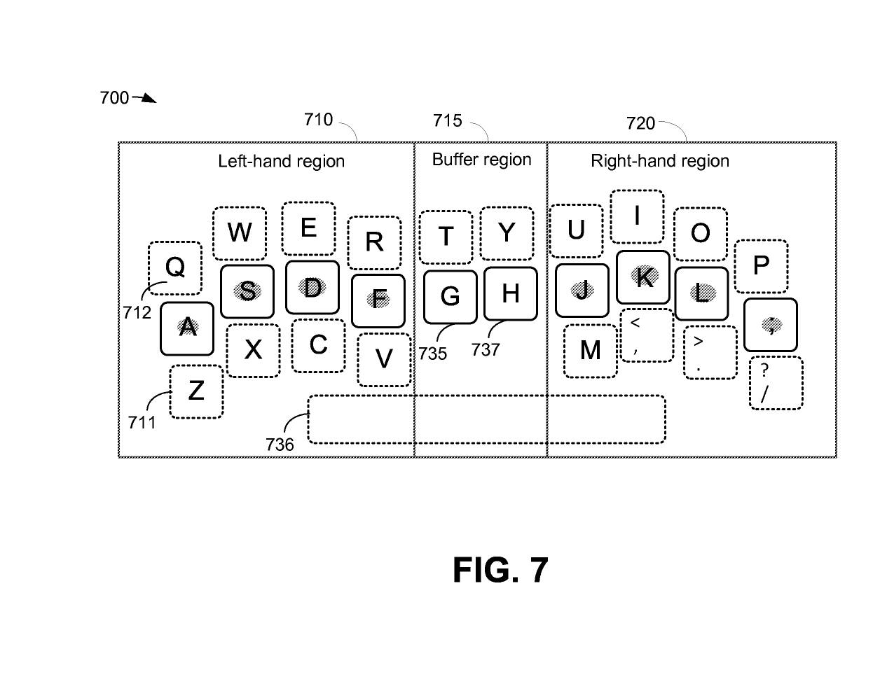

As shown in the embodiment illustrated in FIG. 8, when the wireless device 100 includes a touch-sensitive input/output device 116 that is too small to render separate single character keys and is configured to do so, the wireless device 100 presents a pseudo QWERTY keyboard (i.e., an operator customized keyboard with multiple character keys in a row above and adjacent to the home row keys and multiple character keys in a row below and adjacent to the home row keys). Once a desired keyboard is rendered, as indicated in block 314, the wireless device 100 enters an operational mode where touch inputs entered by an operator of the device are recorded and communicated via an API 270 to application software 104, which may further direct the inputs to one or more remote device.

In an exemplary embodiment, the wireless device 100 includes a digitizer that can be configured to report the area of each touch point, such that the size of the key can vary based on the average size of the touched areas. The most recent size reading applies to the entire keyboard. Area A in the equation below is stored in pixels and is defined by the area of an ellipse: πab, where a and b are the lengths of the major and minor axes, each in pixels. The unit length L of a key (in pixels) as a function of area is defined as follows:

$$L = 90 * ( 1 + \frac{A}{150} )$$

As shown in the above equation, area can only increase key size above the default value.

In an exemplary embodiment, the wireless device 100 may comprise a pressure-sensitive digitizer, such that the unit length of a key varies with the average of the most recent pressure readings of each touch point. The most recent reading applies to the entire keyboard. Pressure P in the below equation can be stored as a percentage where 0% is indicative of no contact and 100% is the digitizer's maximum reading. The unit length L of a key (in pixels) as a function of pressure is defined as follows:

L=90*(1+P)

As shown in the above equation, pressure can only increase key size above the default value. If touch point size and pressure are both enabled, the length equation is given as follows:

$$L = 90 * ( 1 + \frac{A}{150} + P )$$

As further indicated in block 312, the anatomical model 230 in response to the layout parameters 235 and logic may also group sets of non-home row keys when arranging rows above and below the home row keys. FIG. 8 is a schematic diagram 800 showing an embodiment of key grouping.

The keyboard module 200 can group adjacent keys into a single virtual key and present the concatenation of each key's label on the grouped character key. In an exemplary embodiment, in a row adjacent and above the home row keys, the Q, W and E keys are combined into a single virtual key 802, the R, T and Y keys are combined into a single virtual key 804, and the U, I, O and P keys are combined into a single virtual key 806. The row above the home row keys further includes a “Bksp” or backspace key 814, the operation of which decrements a counter 214 in the history module 210 and/or in context with a recent adaptation of the represented keyboard, directs the adaptation module 240 to return to the previous arrangement. In a separate and distinct row adjacent and below the home row, the Z, X and C keys are combined into a single virtual key 808, the V and B keys are combined into a single virtual key 810, and the N and M keys are combined into a single virtual key 812. As further indicated in FIG. 8, additional punctuation or special purpose keys can be added as desired. Character grouping in conjunction with the prediction module 250, the dictionary 167, and key adaptation is beneficial as it can both potentially reduce the number of operator inputs required while increasing the accuracy of the information entered by the operator.

The keyboard module 200 is arranged to predict when a string of entered characters indicates an operator intention to enter a particular word previously stored within the dictionary 167. A character sequence is determined from fingertip taps or operator inputs in registration with the rendered grouped keys and single character keys of the home row. The dictionary 167 stores words and the number of times each word has been typed, and this history information can be queried with incomplete input, that is, with a string of one or more characters as they are being entered by an operator of the wireless device 100. For example, the dictionary 167 information may include “(APPEAL, 1), (APPLE, 9)”. These entries indicate that the word “APPEAL” has been typed one time previously and that the word “APPLE” has been entered nine times. These entries may be stored in association with an operator account if the wireless device 100 is capable of supporting multiple operator accounts. If the prediction module 250 queries the dictionary 167 with A {UIOP} {UIOP}* in the absence of any other words sharing that initial character string, the prediction module 250 would conclude with a 90% confidence score that the letter “L” will come next and would further conclude with a 10% confidence score that the letter “E” will come next. The prediction module 250 communicates this information to adaptation module 240, which uses the information to adjust the size and spacing of these keys before communicating the size/spacing information to the GPU 105 for rendering. In the example embodiment, the wireless device 100 may increase the size of the L character key to increase the likelihood that a next touch input entered by the operator would fall within the area of the touch-sensitive input/output device 116 associated with the character L.

For example, consider the tap pattern: {GH}, {UIOP}, {NM}, {QWE}. The keyboard module 200 and more specifically, the prediction module 250 queries the dictionary 167 (FIG. 1) for words matching the regular expression pattern [GH][UIOP][NM][QWE] and, in an exemplary embodiment, is able to determine the word “HOME” was intended. The prediction module 250 communicates this information to the adaptation module 240, which instructs the GPU 105 to generate the word “HOME” at a desired location in the display 157.

In an exemplary embodiment, the keyboard module 200 may attempt to modify the adaptable keyboard based on a statistical likelihood of the operator's intended action. For example, key actuation and word use is recorded in one or both of the history module 210 and the dictionary 167 (FIG. 1). When an operator begins typing a word, the keyboard module 200 records the key actuations in the dictionary 167 and/or the history module 210, accesses the dictionary 167 and attempts to predict a subsequent letter based on the letters that have been typed, as described above.

A word can also be “unlearned” if desired by the operator by actuating a particular key, for example, the “Bksp” or backspace key 814. The effect of unlearning is that the size and position of the keys are changed to undo the last change to the adaptable keyboard.

Some patterns match multiple words. For example, the pattern {RTY}, {GH}, {UIOP}, {S} matches both THIS and THUS. In this case, the keyboard module 200 ranks the possible matches by historical word usage and presents a list of auto-complete options sorted in descending order of usage. If the operator presses the space bar or another key rendered for the purpose of selecting, the highest-ranked suggestion is used. In addition, the touch sensitive input/output device 116 may be arranged to accept gestures and/or may be adjusted to include additional keys or controls for selecting a suggestion other than the highest-ranked suggestion.

The keyboard module 200 may require the operator to enter new words into the dictionary 167 before they can be recognized and processed by the prediction module 250. To accomplish this, the keyboard module 200 may provide an alternative interface for the operator to enter custom words in the dictionary 167. For example, the application software 104 may present a stock or other keyboard for an operator to use when entering custom words in the dictionary 167. In other embodiments, a dictionary or dictionaries may be imported from an external device coupled wirelessly or via a wired connection to the wireless device 100.

FIG. 9 is a schematic diagram showing an embodiment of non-rectangular keys. The keyboard 900 illustrates the use of closed regions for keys instead of rectangular shapes. For example, the closed region 902 is an example of a non-rectangular shaped key region. As indicated in the illustrated arrangement, non-rectangular keys may include one or more straight line segments when the non-rectangular key is adjacent to a border of the display 157 of the touch-sensitive input/output device 116. As also indicated in the illustrated arrangement, non-rectangular keys may include one or more segments that are convex and one or more segments that are concave.

In an alternative embodiment, the adaptation module 240 may be arranged to instruct the GPU 105 to render non-linear border segments for non-rectangular keys that are adjacent to a bezel or edge of the display 157. When so instructed a border or frame of shaded pixels may be inserted between closed regions and the edge of the display 157.

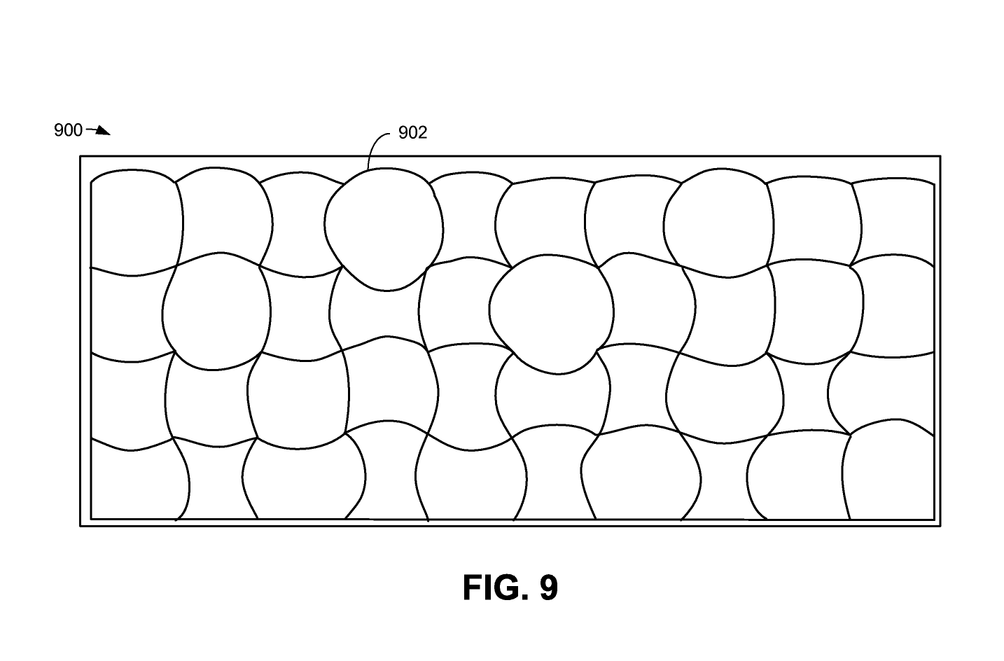

FIG. 10A is a schematic diagram illustrating an overlap condition or conflict between example adjacent keys 1000. As indicated in the example, home-row key A has been enlarged and is overlapping or conflicting with adjacent key W. An overlapping or conflicting condition exists when a last modified or adjusted key prevents the entirety of an adjacent key from being visible to the operator of the wireless device 100. The size of each key may be modified based on a number of measured or recorded parameters, including, for example, frequency of use, the average pressure applied when the operator selects the key associated with that region of the touch-sensitive input/output device 116 and the location where an operator's fingertip touches the area on the screen having that particular key. As indicated in FIG. 10B, the adaptation module 240 responds by relocating the W key so that the key associated with the character A is no longer overlapping or conflicting with the area of the touch-sensitive input/output device 116.

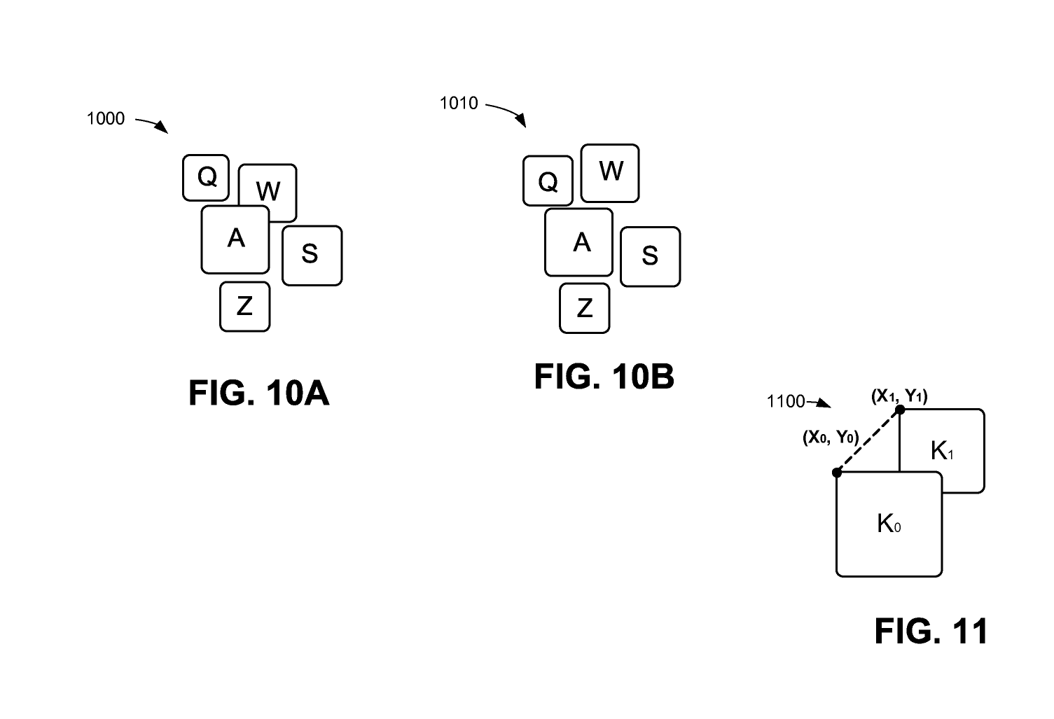

FIG. 11 is a schematic diagram illustrating identification of a respective reference before moving an overlapping key. As shown in the example embodiment, adjacent keys 1100 include a first reference point (X₀, Y₀) of a first key K₀ and a second reference point (X₁, Y₁) of a second key K₁. The first reference point and the second reference point are selected from the upper-left corner of the respective keys. In alternative embodiments, another corner or a centroid of the respective keys can be used as a reference for relocating or repositioning one of the adjacent keys with respect to the remaining key to correct the overlap condition.

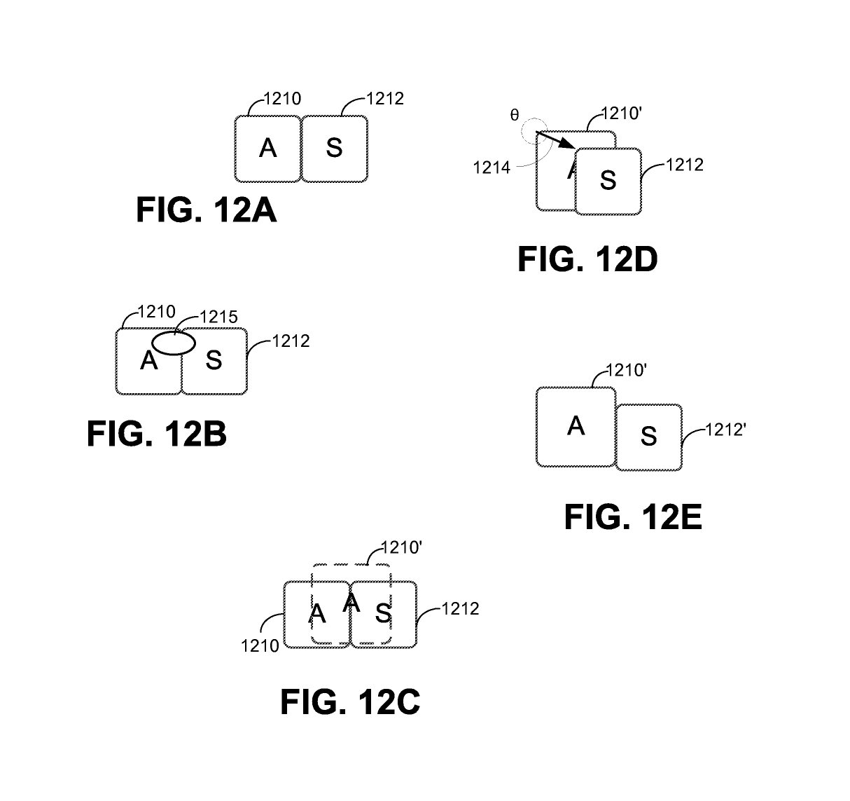

FIGS. 12A-12E include respective schematic diagrams illustrating the creation, identification and correction of an overlap condition for adjacent keys. FIG. 12 A illustrates an original layout of adjacent home-row keys. A first key 1210 is associated with the letter “A”. A second key 1212 is associated with the letter “S”. The first key 1210 and the second key 1212 are adjacent and nearly in contact with each other along respective adjacent edges. For any number of reasons, as indicated by the oval 1215 illustrated in FIG. 12B, an operator of the adaptable keyboard rendered on the display 157 of the touch-sensitive input/output device 116 taps or contacts the surface of the touch-sensitive input/output device 116 at a location that is off-center from the rendered key 1210. Over time as subsequent operator inputs are recorded by the history module 210, the adaptation module 240, more specifically, the relocation module 244, adjusts the size and location of the key 1210 such that it is closer to the actual position of the operator inputs for the key as indicated by the broken line in FIG. 12C.

Move limits are applied by the adaptation module 240 to ensure that keys do not drift dramatically in response to a single key tap. However, even with move limits, it is still possible for a neighbor key to be moved using the overlap avoidance procedure described previously and overlap with its neighbor key. Some embodiments may leave this conflict unresolved because the move limits prevent the overlap from being a substantial proportion of the key. Furthermore, the overlap will be resolved once either of the overlapping keys is pressed. If desired, however, the overlap avoidance algorithm could be repeated for each set of overlapping keys until the entire keyboard is free from overlaps.

When two keys are determined to be overlapping, such as the first key 1210′ and the adjacent key 1212 in FIG. 12C, a vector is derived to determine how far and in which direction the neighbor or overlapping key 1212 should move. The vector, as indicated by the arrow 1214 in FIG. 12D, is determined by calculating or determining an angle (e.g., in degrees counter-clockwise from a horizontal reference) between the first key 1210′ and the overlapping key 1212. A respective reference point is selected to facilitate the determination of the angle of rotation. That is, when an overlapping condition exists, the adaptation module 240 is configured to determine an angle between respective points or locations of the adjacent key and the last modified key. The angle identifies a direction to the move the adjacent key in a cardinal direction identified by entries in the table that follows. As shown in FIG. 12D, the angle between the two keys is derived from the coordinates of their top-left corners. The angle between the two keys in degrees counter-clockwise from horizontal or along the X direction is given by the following equation:

$$θ = {tan}^{- 1} ( \frac{{Y}_{1} - {Y}_{0}}{{X}_{1} - {X}_{0}} )$$

The following parameters are stored for each key:
Xᵢ—X-coordinate of the top-left corner of the key;
Yᵢ—Y-coordinate of the top-left corner of the key;
Wᵢ—Width of the key;
Hᵢ—Height of the key;
Mx—Vertical margin between keys; and
My—Horizontal margin between keys.

In an embodiment, the keyboard module 200 defines a coordinate grid starting at the top-left corner of the screen with +Y moving down and +X moving right. Once the angle between the two keys has been determined, the direction and distance to move the overlapping key can be determined by the following table. As illustrated in FIG. 12E, the overlapping key 1212′ is translated or moved in the +/−X or +/−Y directions, i.e., a direction that parallels the bezels or edges of the display 157. The adjacent key is moved or translated in the direction identified by the angle until the overlap condition no longer exists. That is, as a result of the application of the functions in the table, an overlapping key is adjusted by a minimum distance in a cardinal direction along the surface of the touch-sensitive input/output device 116.

| Angle | Move K₁ | New X₁ | New Y₁ |
|---|---|---|---|
| 0° ≦ θ < 45° | Right | X₀ + W₀ + M_{X} | Y₁ |
| 315° ≦ θ < 360° | | | |
| 45° ≦ θ < 135° | Up | X₁ | Y₀ − H₁ − M_{Y} |
| 135° ≦ θ < 225° | Left | X₀ − W₁ − M_{X} | Y₁ |
| 225° ≦ θ < 315° | Down | X₁ | Y₀ + H₀ + M_{Y} |

The anatomically adaptable keyboard provides several benefits over traditional software keyboards. The adaptable keyboard requires less accurate touches from the operator because it groups keys into regions so one button represents multiple potential symbols or characters, and then uses an internal dictionary to resolve tapped regions associated with multiple letters into words. The initial size of the key is determined by the size of a fingertip's contact region with the screen and the pressure applied. Keys increase and decrease in size and shape with use of the adaptable keyboard, and may translate (i.e., move in one direction over time from a first or calibration position) based on how they are pressed, including letter frequency and the location of the tap relative to the center of the key. By recording the location, size and pressure of operator inputs when the adaptable keyboard is in use as an input device, the wireless device 100 adapts or modifies the representation of the keyboard in accordance with how the operator is using the keyboard. The next letter to be typed is predicted by analyzing historical word usage and analyzing the possible next letters given a sequence of letters or groups of letters. The keys that are determined to be more likely to be pressed are increased in size relative to the others. Traditional prediction focuses on complete words, not individual letters. In the event that a predicted next character was incorrect or the operator made a mistake, layout modifications due to a key press are able to be unlearned when the operator presses the backspace key. This approach allows the keyboard module 200 to self-correct or adjust over time.

In view of the disclosure above, one of ordinary skill in programming is able to write computer code or identify appropriate hardware and/or circuits to implement the disclosed invention without difficulty based on the flow charts and associated description in this specification. Therefore, disclosure of a particular set of program code instructions or detailed hardware devices is not considered necessary for an adequate understanding of how to make and use the invention. The inventive functionality of the claimed computer implemented processes is explained in detail in the above description and in conjunction with drawings, which illustrate various process flows or intermediate steps and/or results.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of non-transitory instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the device or methods for adapting a keyboard on a wireless device, as defined by the following claims.

What is claimed is:

1. A method for adapting a representation of a keyboard on a wireless device, the method comprising:
using a touch-sensitive input/output device to receive substantially simultaneous respective inputs from an operator's fingers at rest and in contact with the touch-sensitive input/output device;
determining spatial parameters from the respective inputs; and
rendering on the touch-sensitive input/output device, a first set of keys in response to the spatial parameters.

2. The method of claim 1, wherein the spatial parameters are selected from the group consisting of the size of an impression from any one of the operator's fingers in contact with the touch-sensitive input/output device and a distance between adjacent impressions.

3. The method of claim 1, further comprising:
determining a pressure applied to the touch-sensitive screen from at least one of the respective inputs, wherein rendering the first set of keys is further responsive to the pressure applied to the touch-sensitive screen.

4. The method of claim 1, further comprising:
subdividing the touch sensitive screen into a first region, a second region and an intervening buffer region; and
prompting the operator to place fingertips of a respective hand in contact with the touch-sensitive screen in the first region and the second region.

5. The method of claim 1, wherein rendering a first set of keys includes rendering a first subset of home row keys.

6. The method of claim 5, further comprising:
rendering non-home row keys based on the first subset of home row keys.

7. The method of claim 6, wherein rendering of non-home row keys includes grouping two or more characters with a single key.

8. The method of claim 6, further comprising:
transitioning the wireless device to an operational mode; and
enabling logic arranged to determine an operator intended character based on a dictionary entry or a measure of frequency of previously entered characters.

9. The method of claim 8, further comprising:
changing a visual characteristic of a rendered key.

10. The method of claim 8, further comprising:
generating at least two sounds, wherein a first sound is associated with a key strike and a second sound distinct from the first sound is associated with a key release.

11. The method of claim 8, further comprising:
vibrating the mobile device with a variable intensity responsive to the distance between an operator's impression on the touch-sensitive screen and the center of the rendered key.

12. The method of claim 8, wherein when the logic is unable to identify a unique intended character, a historical usage record is used to render possible entries in a sequence.

13. The method of claim 12, wherein possible entries include a next subsequent character.

14. The method of claim 12, wherein possible entries include two or more characters the concatenation of which with preceding characters forms a word.

15. The method of claim 8, further comprising:
rendering a key that when associated with a detected operator input in registration with the key decrements a count in a recorder.

16. The method of claim 6, further comprising:
rendering a second subset of home row keys based on relative locations derived from a rendered key associated with a left-hand index finger and a rendered key associated with a right-hand index finger.

17. The method of claim 16, wherein rendering the second subset of home row keys includes:
defining a line between respective locations of the key associated with the left-hand index finger and the key associated with the right-hand index finger; and
partitioning the line.

18. The method of claim 6, further comprising:
adapting a location of any key based on historical information responsive to the location of impressions relative to the rendered keys.

19. The method of claim 18, further comprising:
checking a condition of adjacent keys to a last modified key;
when an overlap condition is identified, determining an angle between respective locations of the adjacent key and the last modified key;
identifying a direction to move the adjacent key; and
translating the position of the adjacent key until an overlap condition no longer exists.

20. The method of claim 6, further comprising:
adapting a size of any key based on historical information responsive to the location of impressions relative to the rendered keys.

21. The method of claim 6, further comprising:
identifying substantially simultaneous operator inputs; and
enabling a feedback mechanism.

22. The method of claim 21, wherein characters associated with keys in registration with the operator inputs are not communicated to an application interface.

23. The method of claim 6, wherein after an impression is identified and recorded as a key strike, a subsequent set of impressions associated with any two of the first set of keys enables a feedback mechanism and the respective characters associated with the any two keys in registration with the subsequent set of impressions are not recorded or communicated to an application interface.

24. The method of claim 6, wherein at least one of the home row keys or at least one of the non-home row keys is non-rectangular.

25. The method of claim 1, wherein a size of at least one of the first set of keys is altered from a default size based on a measured parameter.

26. A wireless device, comprising:
a touch-sensitive input/output device arranged with a digitizer and a display;
a baseband subsystem in communication with the touch sensitive input/output device, the baseband subsystem including;
a processor;
a graphics processing unit coupled to the processor; and
a memory coupled to the processor via a bus, the memory arranged with a keyboard module having at least a calibration detection module responsive to substantially simultaneous respective inputs from an operator's fingers at rest and in contact with the touch-sensitive input/output device.

27. The device of claim 26, wherein the keyboard module includes an anatomical module that receives information from the calibration detection module and is arranged to generate commands that when processed by the graphic processing unit direct the touch sensitive input/output unit to render a first subset of home row keys, a second subset of home row keys and non-home row keys the locations of which are derived from select members of the first subset of home row keys.

28. The device of claim 26, wherein the keyboard module includes a history module that receives information from the touch sensitive input/output device and forwards modified information indicative of one or more characters associated with respective operator inputs to an adaptation module arranged to generate commands that when processed by the graphic processing unit direct the touch sensitive input/output unit to adjust at least one of a first subset of home row keys.

29. The device of claim 28, wherein the adaptation module is further arranged to undo a most recent adjustment to the rendered keys upon detection of an operator selection of a key rendered for such a purpose.

30. The device of claim 28, wherein the adaptation module is further arranged to generate commands that when processed by the graphic processing unit direct the touch sensitive input/output unit to adjust the size or location of a rendered key in response to information received from a dictionary and the history module.
